(19) United States
(12) Patent Application Publication
(10) Pub. No.: US 2005/0093307 A1
(43) Pub. Date: May 5, 2005

(54) Slam latch and strike assembly

(75) Inventor: Frederick M. Perkins, Ft. Lauderdale, FL (US)

Correspondence Address: LAWRENCE E. LAUBSCHER, SR.;LAUBSCHER LAW OFFICES, 1160 SPA ROAD, SUITE 2B, ANNAPOLIS, MD, 21403, US

(73) Assignee: Perko, Inc., Miami, FL (US)

(21) Appl. No.: 10/697,154

(22) Filed: Oct. 31, 2003

(51) Int. Cl. E05C 19/00

(52) U.S. Cl. 292/300

(57) ABSTRACT

A slam latch and strike assembly for latching together a pair of generally parallel relatively laterally displaceable support members, including a body adapted for connection with one of the support members, a latch member mounted for axial displacement between extended and retracted positions in a transverse opening contained in the body member, a spring biasing the latch member toward the extended position, and a strike member mounted on the other support member adjacent the free end of the latch member when the latch member is in the extended position, the strike and latch members carrying sets of strike teeth and latch teeth that are normally in engagement when the latch is in its extended position, the tips and valleys of the teeth of at least one of the latch and strike teeth sets being curved and convex, thereby to compensate for minor misalignment between the strike and latch members.

### FIELD OF THE INVENTION

A slam latch and strike assembly is provided for latching together a pair of adjacent generally parallel relatively laterally displaceable support members, including a body adapted for connection with one of the support members, a latch member mounted for axial displacement between extended and retracted positions in a transverse opening contained in the body member, a spring biasing the latch member toward the extended position, and a strike member mounted on the other support member adjacent the free end of the latch member when the latch member is in the extended position, the strike and latch members carrying ratcheting sets of strike teeth and latch teeth that are normally in engagement when the latch is in its extended position, the tips and valleys of the teeth of at least one of the latch and strike teeth sets being curved and convex, thereby to compensate for minor misalignment between the strike and latch members.

### BACKGROUND OF THE INVENTION

### Brief Description of the Prior Art

It is well known in the patented prior art to provide latch means for releasably connecting together a pair of laterally movable members, such as the hatch of a ship. Examples of such known latches are set forth in the patents to Tweeddale U.S. Pat. No. 372,645, Murbach U.S. Pat. No. 913,410, Bisbina U.S. Pat. No. 5,346,266, and Johansson, et al., U.S. Pat. Nos. 6,113,160 and 6,575,503, among others. As is known in the art, the ratcheting latch teeth and the strike teeth of slam latch arrangements include linear transverse tips and valleys that are parallel with each other.

One problem experienced in the use of such latches is the difficulty in maintaining proper alignment between the latch and strike members, particularly when the support members are subjected to stress and distortion, such as occurs on marine vessels, aircraft, travel homes, and the like. Another problem is providing a reliable latch assembly that is leak-proof during adverse conditions of weather and use.

The present invention was developed to avoid the misalignment and other drawbacks of the known latch and strike assemblies, and to provide a positive-acting waterproof latch assembly that is reliable and relatively inexpensive to produce.

### SUMMARY OF THE INVENTION

Accordingly, it is a primary object of the present invention to provide a latch and strike arrangement wherein the tips and valleys of at least one of the sets of the ratcheting latch teeth and the strike teeth are curved and supported by a convex surface, thereby to correct for minor misalignment between the latch and strike members. In a first embodiment, the strike has a circular cross-section, while in a second embodiment, the strike has a generally rectangular, polygonal or H-shaped cross-section.

According to a more specific object of the invention, the latch member is spring-biased outwardly toward an extended latched position relative to the body in which it is mounted, and handle means connected with the body operate rack and pinion means to axially displace the latch toward its retracted unlatched position. Furthermore, finger operable safety means are provided on the latch for engagement from within the chamber for manually displacing the latch member against the spring biasing force toward the retracted unlatched position, thereby to permit opening of the hatch from within the hold or chamber.

According to another object of the invention, the latch is mounted for displacement displaceable in a tubular body that has an intermediate divider wall and a removable bottom wall, thereby to afford access to the latch and the operating components therefor. Seal means are provided on the operating handle pivot shaft for sealing latch assembly against leakage. A sealing gasket is also provided concentrically about the latch body. Preferably the components of the latch assembly, including the latch body, the strike, the latch and the handle, are formed from a suitable corrosion-resistant synthetic plastic material. A simple single nut arrangement is provided for mounting the externally threaded body within an opening contained in the associated support member.

### BRIEF DESCRIPTION OF THE DRAWINGS

Other objects and advantages of the invention will become apparent from a study of the following specification when viewed in the light of the accompanying drawings, in which:

FIG. 1 is a perspective view of a first embodiment of the latch and strike assembly of the present invention;

FIG. 2 is an exploded perspective view of the embodiment of FIG. 1;

FIG. 3 is a front elevational view of the body of FIGS. 1 and 2, and

FIGS. 4 and 5 are top and bottom views of the body of FIG. 3;

FIG. 6 is a right hand view of the body of FIG. 3, and

FIGS. 7, 8, and 9 are sectional views taken along the lines 7-7, 8-8, and 9-9 of FIG. 4, respectively;

FIG. 10 is an elevational view of the circular strike member of FIGS. 1 and 2,

FIG. 11 is a sectional view taken along line 11-11 of FIG. 10, FIG. 11a is a detailed view of the strike teeth, and

FIG. 12 is a top plan view of the circular strike member of FIG. 10;

FIGS. 13 and 14 are top and bottom views of the bottom plate of FIG. 2, and

FIGS. 15 and 16 are sectional views taken along lines 15-15 and 16-16 of FIG. 13, respectively;

FIG. 17 is a front elevational view of a handle member of FIG. 2,

FIG. 18 is a left hand view of the handle member of FIG. 17, and FIG. 18 is a sectional view taken along line 19-19 of FIG. 17;

FIG. 20 is a left hand end view of the pinion gear of FIG. 2, and

FIG. 21 is a sectional view taken along line 21-21 of FIG. 20, and

FIG. 23 is a right hand view of the pinion gear;

FIGS. 23 and 24 are elevational and end views, respectively, of the pivot shaft of FIG. 2;

FIGS. 25 and 26 are top and bottom views of the latch member of FIG. 2, and

FIG. 27 is a sectional view taken along line 27-27 of FIG. 25;

FIGS. 28 and 29 are right hand end and left hand elevational views, respectively, of the latch member;

FIGS. 30-33 are side elevation, top, and bottom views, respectively, of the rack of FIG. 2, and

FIG. 33 is a sectional view taken along line 33-33 of FIG. 31;

FIG. 34 is a sectional view illustrating the cooperation between the latch member of FIG. 27 and the round strike member of FIG. 10 for latching together a pair of laterally displaceable support members;

FIG. 35 is an elevational view of a rectangular second strike embodiment of the invention,

FIGS. 36 and 37 are top and bottom views of the strike embodiment of FIG. 35, and

FIGS. 38 and 39 are a right and left hand views, respectively, of the strike member of FIG. 35.

### DETAILED DESCRIPTION

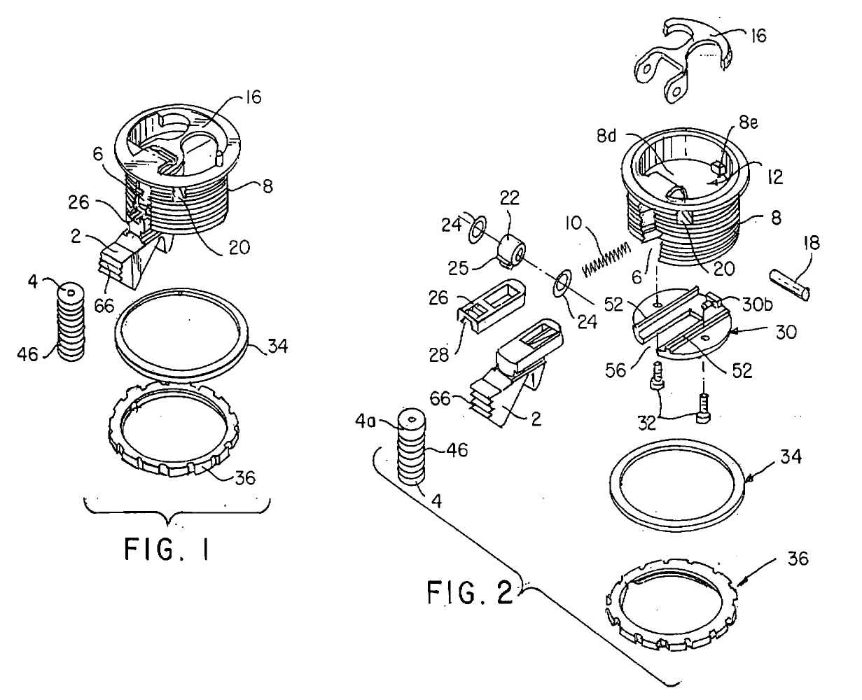

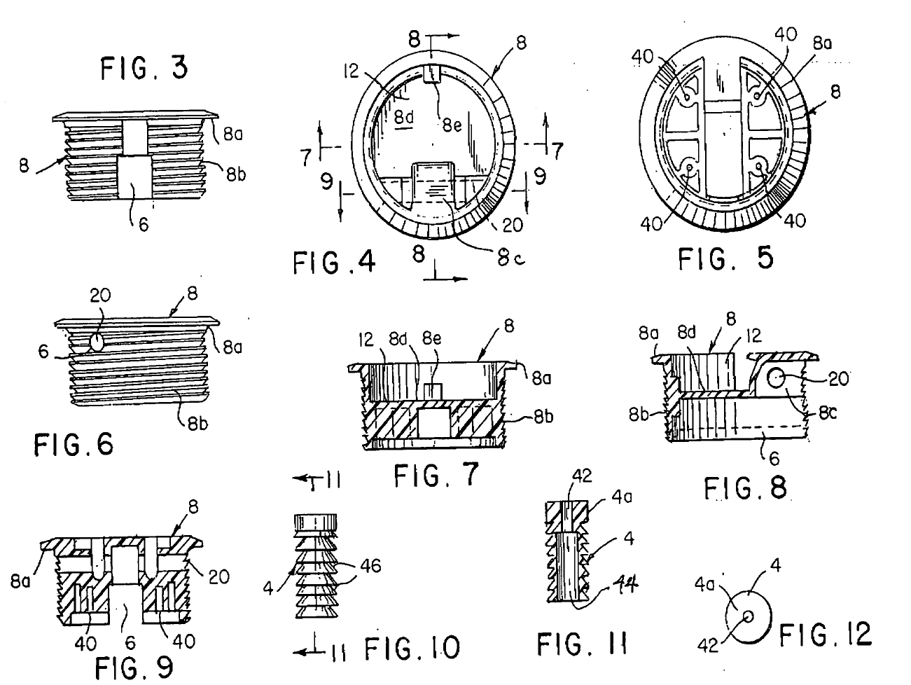

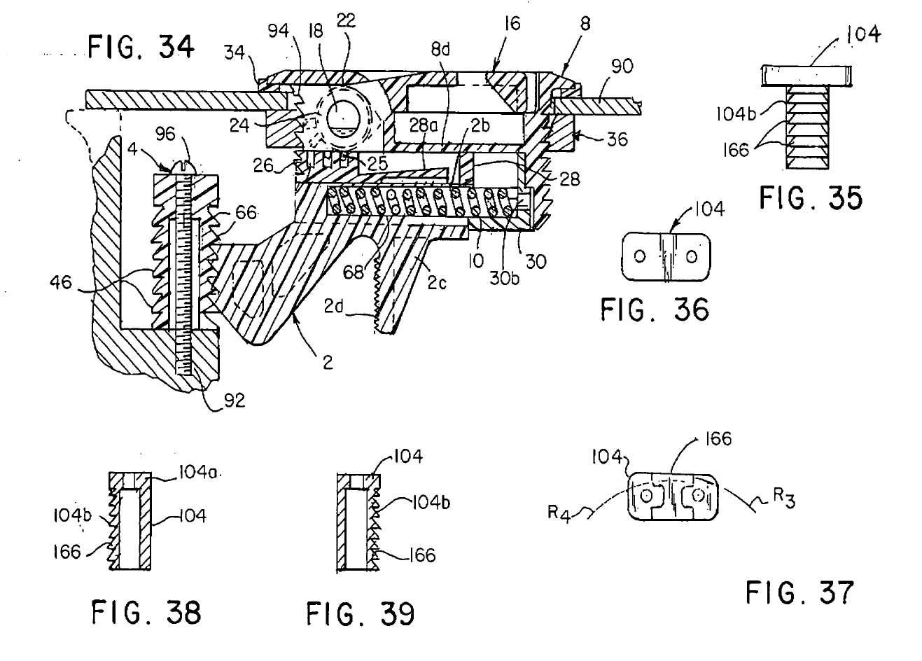

Referring first more particularly to FIGS. 1 and 2, the slam latch and strike assembly of the present invention includes a latch member 2 that is operable to engage a strike member 4, thereby to latch together a pair of support members as will be described below in connection with FIG. 34. The latch member 2 is mounted for sliding displacement within a notch 6 contained in the bottom end of a tubular body 8 below the horizontal intermediate divider wall portion 8d. A compression spring 10 biases the latch member 2 from a retracted position within the central chamber 12 of the body 8 toward the extended position illustrated in FIG. 1. A handle 16 is pivotally connected with the body 8 by means of a pivot shaft 18 that extends through corresponding openings 20 contained in the body 8. The pivot shaft 8 has a non-circular cross-sectional configuration upon which is concentrically and non-rotably mounted the pinion gear 22. Resilient O-ring seals 24 are provided on the shaft 18 at either end of the pinion gear 22, thereby to seal the upper portion of the assembly above the intermediate divider wall 8d. The teeth 25 of the pinion gear 22 engage corresponding teeth 26 of rack 28 that is connected for sliding movement in one direction relative to the latch 2. A bottom plate 30 is removably connected with the bottom end of the body 8 by means of screws 32, and annular gasket 34 and lock nut 36 are adapted to be mounted concentrically about the body 8 as will be discussed in greater detail below.

Referring now to FIGS. 4-9, the body member is of generally tubular construction and includes an annular outwardly directed upper flange portion 8a, an externally threaded tubular wall portion 8b, and an internally enlarged portion 8c in the chamber 12 defined above the divider wall portion 8d. The lower end of the wall portion 8b contains the vertical slot 6 that receives the latch member 2 of FIG. 2. As best shown in FIGS. 4, 8, and 9, the transverse bore 20 that receives the pivot shaft 18 extends through the enlarged body portion 8c contained within the body 8. Handle stop portion 8e is provided within upper chamber 12 adjacent the intermediate wall 8d.

As shown in FIG. 5, the bottom portion of the body 8 contains a plurality of threaded holes 40 for receiving the screws 32 that mount the bottom plate 30 upon the bottom of the housing 8, as will be described in greater detail below.

Referring now to FIGS. 10-12, the first strike embodiment 4 has a circular cross-sectional configuration and is provided at its upper end with a round head portion 4a that contains a through bore 42, the opposite end of the strike being counterbored to define the counter bore 44. In accordance with a characterizing feature of the present invention, the circular strike 4 is provided with a series of vertical strike teeth 46. As best shown in FIG. 11a, the strike teeth have transverse tip portions 46a and valley portions 46b that are curved, since they are on the concentric outer surfaces of the strike member 4. The ratcheting configuration of the strike teeth is such that the flat portion 46c is generally horizontal, and the angular portion 46d extends at an angle of about 45 degrees relative to the horizontal tooth portion 46c.

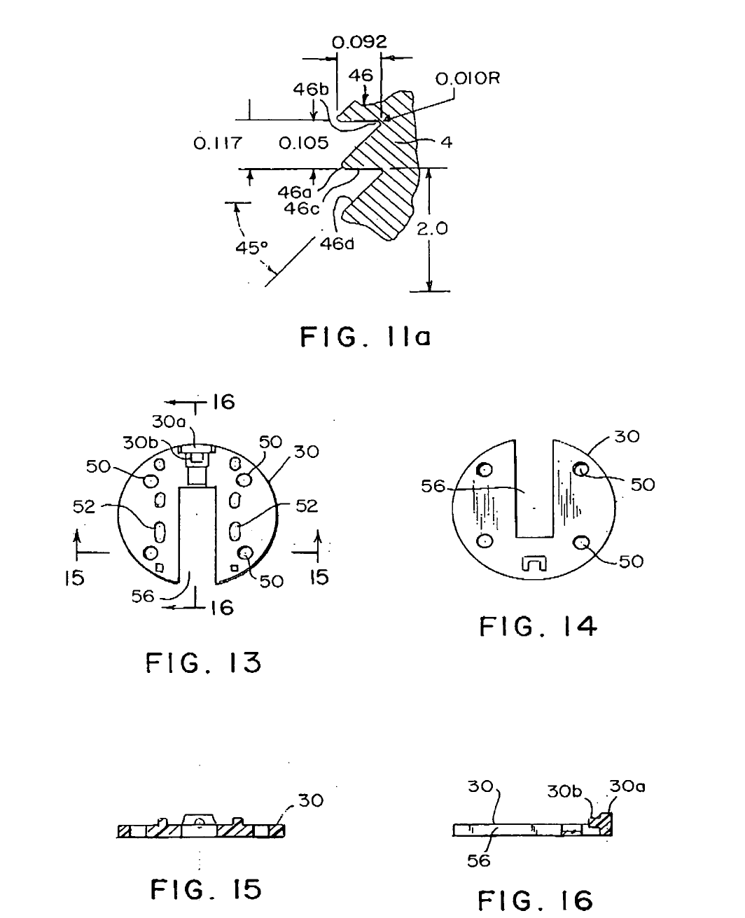

Referring now to FIGS. 13-16, the bottom plate 30 is provided with the through openings 50 that receive the screw means 32, thereby to fasten the bottom plate to the bottom of the body 8. On its upper surface, the bottom plate is provided a pair of parallel guide means 52 that serve to guide the latch member 2 during its displacement between its extended end retracted positions. The latch member 2 is contained within a slot 56 that extends diametrically partially across the bottom plate 30. A spring support portion 30a having a spring support pin 30b is provided for supporting one end of the compression spring 10 As shown in FIG. 34, the other end of the compression spring 10 reacts with the latch member 2 to bias the same toward its outwardly extended position relative to the body 8.

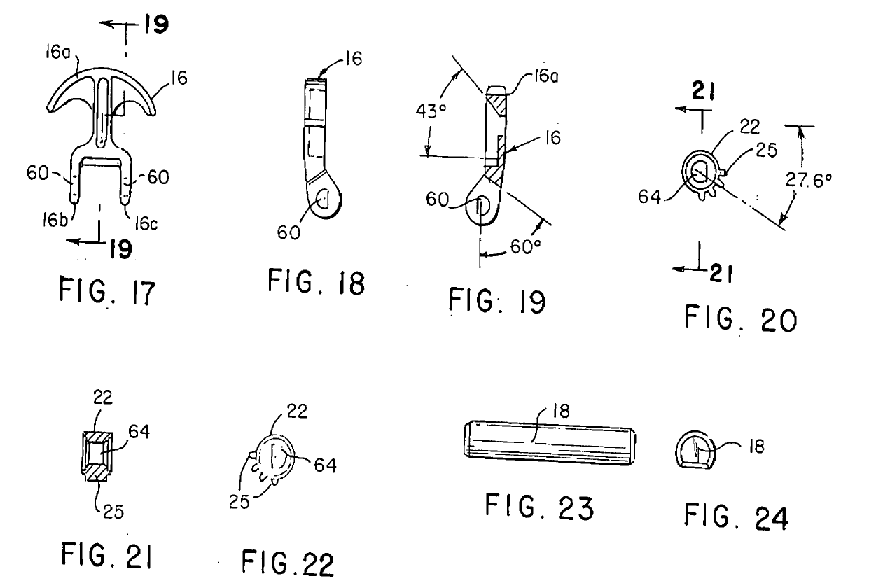

Referring now to FIG. 17-19, the handle 16 includes a handle portion 16a at one end, and a bifurcated leg portion at its other end defining a pair of legs 16b 16c that contain a pair of noncircular aligned openings 60, respectively. The openings 60 are adapted to receive the corresponding ends of the pivot pin 18 which, as shown in FIGS. 23 and 24, has a noncircular configuration corresponding to that of the openings 60. Mounted concentrically in nonrotational relation on the pivot shaft 18 is the pinion gear 22 having pinion teeth 62, as shown in FIGS. 20-22. The cross-sectional configuration of the bore 64 extending through the pinion 22 corresponds with that of the pivot shaft 18, whereby the pinion gear is non-rotatably mounted on the pivot shaft.

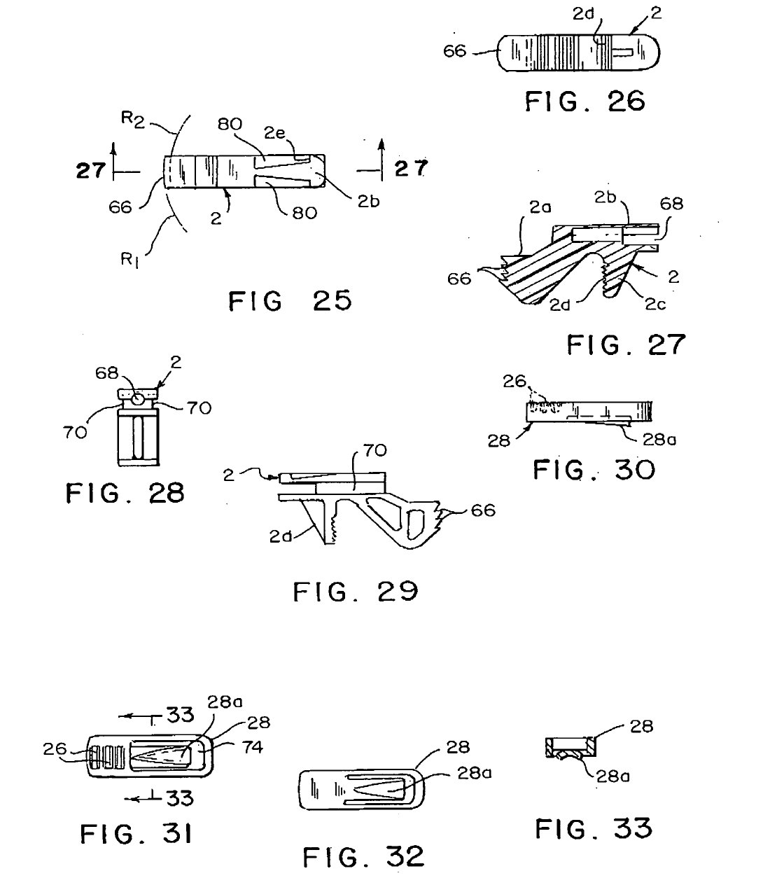

Referring now to FIGS. 25-29, the latch member 2 includes at one end a latch portion 2a provided with a series of vertically arranged ratcheting latch teeth 66 the configuration of which corresponds with the strike teeth 46 of FIG. 11a. At its other end, the latch is provided with a projecting portion 2b that extends horizontally in spaced relation above the finger grip portion 2c of the latch, as best shown in FIG. 27. The right hand end of the latch member is provided with a recess 68 for receiving the other end of the compression spring 10. At each side, the latch is provided with guide grooves 70 that slidably receive the edges of the slot 56 defined in the bottom plate 30. The upper side surfaces of the latch are guided between the guide means 52 on the bottom plate, thereby to accurately guide the latch for displacement relative to the slot 6 contained in the body 8. The finger-operable release portion 2c is provided with a roughed surface 4d for manual displacement of the latch toward the released position by an operator within the space defined by the support members, as will be described below.

Referring now to FIGS. 30-33, the rack member 28 provided with the rack teeth 26 is of general rectangular configuration, and includes an opening 74 that receives the resilient tongue portion 28a which has a downwardly directed concave surface, as best shown in FIG. 33. The lateral wings of the tongue portion 28a 76 are adapted for insertion within the spaces 80 defined on opposite sides of the latch projecting portion 2b, as shown in FIGS. 25 and 34, thereby to afford limited longitudinal displacement of the latch relative to the rack member 28.

Referring now to FIG. 34, the slam latch means of the present invention is utilized to fasten together a pair of generally parallel relatively laterally moveable support members 90 and 92. Thus, the body member 8 is mounted within a hole 94 that is formed in the first support member 90, the flange portion 8a being seated on the gasket 34 seated the upper surface of the support member 90. The lock washer 36 is threadably connected with the externally threaded outer surface of the body 8 to compress the gasket 34 against the upper surface of the first support member 90. When the latch member 66 is in its illustrated extended position of FIG. 34, the latch teeth 66 engage the strike teeth 46 on the strike member 4 that is rigidly connected with the second support member 92 by screw 96. In accordance with a safety feature of the invention, the latch member 2 may be manually displaced axially to the right toward the disengaged position relative to the strike member 4 manually by engagement of the finger portion 2d. Alternatively, the latch may be displaced toward the disengaged position by raising the handle 16 to simultaneously rotate the pinion gear 22, thereby to displace rack 25 and latch 2 to the right toward their disengaged positions. The latch member 2, of course, is displaceable to the right toward the disengaged retracted position against the biasing force of spring 10 until the end extremity of the wing 76 engages the stop surfaces 2d on the projecting portion 2b of the latch member 2. The first support member 90 generally has a thickness of about ⅛″ to about ¾″. And the diameter of the opening 94 is about 2″.

As shown in FIG. 25, in accordance with a characterizing feature of the present invention, the transverse end surfaces of the peaks and valleys of the latch teeth 66 are convex and are curved. Thus, the tips of the latch teeth 66 are curved by the radius R₁ and the valleys of the latch teeth are curved about the radius R₂. Thus, the curved latch teeth 66 cooperate with the correspondingly curved teeth 46 on the strike 4, thereby to compensate for minor misalignment between the latch and the strike, thereby affording the major advantage of the present invention.

Referring to now FIGS. 36-38, instead of a round strike member 4 shown in FIGS. 10-12, the strike member 104 may have a generally rectangular cross-sectional configuration. In this case, the lateral face 104b of the latch member 104 that is adjacent the latch member 2 is convex, and the latch teeth 166 have tips and valleys that are curved by the radii R₃ and R₄, respectively. The configuration of the latch teeth 66 of FIG. 27 and the latch teeth 166 of FIG. 38 correspond with the configuration of the strike teeth 46, as shown in FIG. 11a. Thus, the ratcheting strike and latch teeth have a one-way configuration, thereby to define a slam latch that permits the first support member 90 to be displaced laterally toward the coplanar position 90 with the second support 92 as shown in FIG. 34, but displacement of the first support member 90 in the opposite direction is prevented by the configuration of the strike teeth and the latch teeth. Thus, to open the first support member 90, the latch 2 must be displaced to the right and FIG. 34 either manually by operation of the finger grip 2d or by operating the release lever 16 to pivot the pinion 22 to cooperate with rack 26 and thereby displace latch 2 to its retracted position against the biasing force of compression spring 10.

The O-ring seals 24 concentrically mounted on the shaft at opposite ends of the pinion gear serve to seal the portion of the latch mem\mechanism above the divider wall portion 8d, thereby to seal the portion of the slot 6 contained below the divider wall, as shown in FIG. 8. Preferably, the body 8, end plate 30, handle 16, rack 28, latch 2 and strike 4 are formed of a suitable corrosion-resistant synthetic plastic material. The pinion gear may similarly be formed of the synthetic plastic material, or a non-corrosive metal material, such as brass.

While in accordance with the provisions of the Patent Statutes the preferred forms and embodiments of the invention have been illustrated and described, it will be apparent to those skilled in the art that various changes and modifications may be made without deviating from the inventive concepts set forth above.

1. A slam latch and strike assembly for releasably connecting together two adjacent support members that are relatively displaceable between a generally planar closed position and a relatively laterally displaced open position, comprising:
(a) a generally tubular body adapted for connection with a first one of said support members, said body having a vertical longitudinal axis and a horizontal divider wall defining upper and lower chambers in said body, said body having at its lower end a wall portion containing a transverse opening communicating with said lower chamber;
(b) a latch member mounted in said wall opening for axial displacement between retracted and extended positions relative to said body, said latch member including a first end portion that extends from said housing when said latch member is in said extended position;
(c) spring means biasing said latch member toward said extended position relative to said body;
(d) release means for displacing said latch toward said retracted position relative to said body; and
(e) a strike member adapted for connection with a second one of said support members at a location adjacent said latch first end when said latch member is in said extended position, said strike member having a longitudinal axis generally parallel with said body longitudinal axis;
(f) said latch member first end portion and said strike member having adjacent generally parallel surfaces provided with series of cooperating ratcheting latch teeth strike teeth, respectively,
(1) said latch teeth and said strike teeth being in engagement when said latch is in said extended position and said support members are in said relatively closed position;
(2) the ratcheting configuration of said latch teeth and said strike teeth being such as to permit movement of said support members toward said closed position, but to prevent movement of said support members toward said open position;
(3) at least one of said adjacent latch end and strike member surfaces being convex, the transverse tips and valleys of the teeth carried by said convex surface being curved and having a radius of curvature corresponding generally to the radius of curvature of said convex surface, thereby to compensate for slight misalignment between said latch and strike members..

2. A slam latch and strike assembly as defined in claim 1, wherein both of the adjacent surfaces of said latch and strike member are convex, the tips and valleys of all of said latch teeth and said strike teeth being curved.

3. A slam latch and strike assembly as defined in claim 2, wherein said strike member has a circular cross-sectional configuration.

4. A slam latch and strike assembly as defined in claim 1, wherein said strike member has a generally polygonal cross-sectional configuration.

5. A slam latch and strike assembly as defined in claim 1, wherein said release means includes:
(1) a release handle pivotally connected with said body for pivotal displacement about an axis normal to the plane that contains the longitudinal axes of said body and said latch member, said handle being displaceable between a locked position within said body upper chamber and a released position extending from said body chamber; and
(2) rack and pinion gear means connecting said latch member with said handle for displacement between said extended and retracted positions relative to said body when said handle is in said locked and released positions, respectively.

6. A slam latch and strike assembly as defined in claim 5, wherein said body wall transverse opening comprising an axially extending slot contained in the bottom end of said body member; and further including:
(g) an end plate connected with said body member to close said body member bottom end.

7. A slam latch and strike assembly as defined in claim 6, wherein said end plate contains guide means for guiding said latch member during the displacement thereof between said extended and retracted positions relative to said body member.

8. A slam latch and strike assembly as defined in claim 5, wherein the upper end of said body member includes an outwardly extending external annual flange portion adapted for seated engagement with the adjacent surface of the first support member when said body member is mounted in a corresponding opening contained therein, said body member being externally threaded; and further including:
(g) lock nut means threadably connected with said body member beneath the first support member, thereby to lock said body member to the first support member.

9. A slam latch and strike assembly as defined in claim 8, and further including a pivot shaft non-rotatably connected with said release handle, said rack and pinion means including a pinion gear non-rotatably connected with said pivot shaft for angular displacement with said release handle, and O-ring seal means mounted on said pivot shaft, thereby to seal the assembly against leakage.

10. A slam latch and strike assembly as defined in claim 9, and further including an annular gasket arranged concentrically about said body, said gasket being compressed between said body annular flange portion and the adjacent surface of the first support member.

11. A slam latch and strike assembly as defined in claim 5, and further wherein said rack and pinion means includes a rack member, said latch member being connected for sliding movement relative to said rack member in the retracted direction against the biasing force of said spring means.

12. A slam latch member as defined in claim 5, wherein said body, latch member, handle member, rack, rack and strike are formed from a corrosion-resistant synthetic plastic material.
